(19) United States
(12) Patent Application Publication
(10) Pub. No.: US 2025/0020091 A1
(43) Pub. Date: Jan. 16, 2025

(54) INJECTOR FOR INJECTING FUEL

(71) Applicant: LIEBHERR-COMPONENTS DEGGENDORF GMBH, Deggendorf (DE)

(72) Inventor: Martin SEIDL, Deggendorf (DE)

(21) Appl. No.: 18/714,447

(22) PCT Filed: Dec. 14, 2022
(86) PCT No.: PCT/EP2022/085910

§ 371 Date: May 29, 2024

(30) Foreign Application Priority Data
Dec. 15, 2021 (DE) 10 2021 133 210.9

(51) Int. Cl. F02M 21/02; F02M 51/06

(52) U.S. Cl. CPC F02M 21/0254; F02M 21/0206; F02M 51/0689

(57) ABSTRACT

The present invention relates to an injector for injecting fuel, preferably for injecting a gaseous fuel, in particular hydrogen, which comprises a fuel feed line for introducing a gaseous fuel under high pressure, an active valve which is actively switchable and is configured to close or release at least one passage in order to selectively release or interrupt a flow connection from the fuel feed line to an area downstream of the active valve, and a passive valve which is arranged downstream of the active valve and can be passively switched into a closing or releasing state by different pressure conditions applied upstream and downstream of the passive valve in order to selectively release or interrupt a flow connection from upstream of the passive valve to an area downstream of the passive valve.

The present invention relates to an injector for injecting fuel, in particular for injecting a gas, preferably for directly injecting hydrogen. It may be provided that the injector is configured to inject fuel into a combustion chamber of an internal combustion engine.

In the wake of ever stricter exhaust emission limits worldwide and ambitious climate protection targets, the environmental requirements for combustion engines are constantly increasing. The aim in the foreseeable future is to achieve low-emission or even emission-free drive technologies that meet even the strictest exhaust emission limits and make a significant contribution to achieving climate protection targets. For technologies that work with combustion, these targets can only be achieved by using climate-neutral, regeneratively produced fuels that do not cause any emissions along the entire value chain (so-called “zero emissions” fuels).

With current conventional petrol, diesel and gas engines, the requirements for emission-free combustion-even when using so-called e-fuels, e.g. a synthetically produced OME fuel that only requires renewable energy for its production-cannot be achieved, as the emission of harmful exhaust gases such as nitrogen oxides (NOx), unburned hydrocarbons (UHC) and soot cannot be completely reduced with current technologies.

In principle, battery-powered drives comply with the Zero Emissions Directive during operation and are gaining ground in the passenger car sector in particular. However, if the entire value chain is considered, the production of (lithium) batteries is very costly in terms of energy and problematic from an environmental point of view, as the extraction of raw materials is particularly damaging to the environment and the extraction of the raw materials required for the batteries cannot be carried out sustainably. In addition, the power-to-weight ratio of batteries currently achievable means that they cannot be used in machines with high (peak) power requirements.

Fuel cell-powered drives with a supply of regeneratively produced hydrogen meet the specified climate protection targets and are already in use today to a very limited extent. However, this concept also has some disadvantages, such as low peak power and low economic efficiency compared to today's diesel drives.

The focus has therefore shifted to hydrogen combustion engines, which represent a promising alternative drive system. To date, however, these exist almost exclusively in very small numbers or as demonstrators with a low degree of maturity. Hydrogen produced from renewable energies would meet all the requirements of “zero emission”, as it can be burned without emissions.

In the passenger car sector, for example, there are hydrogen engines with external fuel injection (PFI=port fuel injection), in which the fuel is thoroughly mixed with air in sufficient time before entering the combustion chamber. Hydrogen engines with direct injection of the fuel into the combustion chamber (DI=direct injection) play practically no role today, but compared to the PFI concept, they have higher efficiency, more stable combustion and eliminate the risk of re-ignition in the intake tract.

In direct-injection hydrogen engines, a distinction is typically made with regard to the maximum injection pressure in the injector (<60 bar: low pressure, >60 bar: high pressure), wherein the limits are not clearly defined and the transitions are fluid. Higher pressures offer the potential of a shortened injection duration in a later phase of compression at higher combustion chamber pressures, which results in increased efficiency and improved combustion stability. However, the overall efficiency decreases if compression of the hydrogen is required beforehand.

If the hydrogen is obtained 100% from renewable energies, hydrogen combustion engines can be operated in an almost climate-neutral manner. There are also numerous other advantages:
Use of known technologies with a high degree of maturity and existing production facilities
Unlimited availability of hydrogen through electrolysis of water
Use of the existing filling station system possible (after appropriate conversion) with fast refueling times
(almost) emission-free conversion of hydrogen in combustion possible, as CO₂-neutral, only minimal CO, UHC, particulate and soot emissions (only caused by lubricants in the feed system, below the measurement limit) and only minimal NOx emissions due to suitable combustion process (possibly with exhaust gas recirculation, SCR catalytic converter)
Significantly lower hydrogen purity requirements compared to fuel cell drives.
No need for platinum for production as with fuel cells

However, in addition to these numerous advantages over other drive concepts, there are also some challenges that need to be overcome in the development of hydrogen combustion engines:
Low molecular weight of hydrogen, resulting in a low density combined with a low volumetric energy density (with a high mass-specific energy density); see Table 1
Provision of a consequently high volume flow during the injection of hydrogen
Corresponding provision of large flow cross-sections in the injector and therefore significantly larger actuator strokes required than with conventional drive types
development of a significantly more powerful actuator unit with limited installation space
Tightness of the overall system/prevention of external leaks, especially with regard to safety aspects (risk of fire and explosion due to hydrogen escaping from the system)
Increased risk of wear on guides of moving components due to the virtually non-existent lubricating effect of hydrogen
Significantly greater tendency of moving components to bounce on mechanical stops in gas injectors compared to injectors with liquid fuels due to low damping effect during gas compression
Material resistance to hydrogen necessary with regard to the risk of hydrogen embrittlement in mechanically stressed/pressurized components (reduced strength) or due to chemical reaction of the hydrogen with oxygen present in the copper coil of the actuator (hydrogen sickness of the copper)
Mixture preparation in the combustion chamber/Influence on the injection jet/Ignition behavior with low volume injection

TABLE 1
Mass and volume-specific calorific value of diesel and hydrogen

| | Diesel | Hydrogen (at 25° C.) |
|---|---|---|
| Calorific value in MJ/kg | 43.0 | 120.0 |
| Calorific value in MJ/m³ | 35′819 | 9.8 at 1 bar |
| | | 287.7 at 30 bar |
| | | 2464.4 at 300 bar |

It is the object of the present invention to at least partially overcome or mitigate the disadvantages listed above. In particular, the object is to provide a fuel injector which has particularly low wear and thus improved robustness and resistance. In addition, it is desirable to provide an injector in which the mass flow of the dispensed fuel is easy to predict and is not subject to fluctuations, i.e. a smooth curve in the injection rate or injection rate is achieved (e.g. by reducing bounce effects on valves).

At least some or all of the aforementioned objects are achieved by means of an injector for injecting fuel, which comprises all of the features of claim 1. Advantageous embodiments of the injector are specified in the dependent claims.

An injector according to the invention for injecting fuel, preferably for injecting a gaseous fuel, in particular hydrogen, comprises a fuel feed line for introducing a gaseous fuel under high pressure, an active valve, which can be actively switched and is configured to close or open at least one passage in order to selectively open or interrupt a flow connection from the fuel feed line to an area downstream of the active valve, and a passive valve, which is arranged downstream of the active valve and can be passively switched to a closing or releasing state by different pressure conditions applied upstream and downstream of the passive valve in order to selectively release or interrupt a flow connection from upstream of the passive valve to an area downstream of the passive valve. The injector is characterized in that a reciprocating tappet (or valve insert) of the passive valve comprises a permanent magnet or is a permanent magnet, and a tappet guide is provided for guiding the reciprocating movement of the tappet, which is electrically conductive and non-magnetizable or only weakly magnetizable. Within the scope of the invention, the materials of which the tappet and the tappet guide are made can also be interchanged, as shown in claim 1.

Due to the design with a permanently magnetic tappet and non/weakly magnetizable, electrically conductive tappet guide, eddy currents are induced in the tappet guide when the valve is opened and closed, which in turn induce a magnetic field that counteracts the original magnetic field of the tappet (according to Lenz's rule). In accordance with the principle of the eddy current brake, a magnetic force opposing the movement acts on the tappet during the opening and closing process, slowing down the movement. This braking force is proportional to the speed at which the tappet moves, i.e. the more it is accelerated by pressure forces and/or spring force, the more the movement is damped by the induced eddy currents. At the beginning of the movement when opening or closing, the speed is very low, so that there is initially no negative influence on the dynamics of the fuel delivery. With increasing speed and/or increasing distance from the respective stop, the magnetic damping effect increases. This reduces the impact speed of the tappet on a counter stop. This reduces wear and increases the robustness of the design, as the forces acting on the tappet on impact are reduced. In addition, a smooth injection or injection rate curve is achieved (bouncing of the tappet in the stroke range, in which no throttling takes place, would otherwise lead to dips in the rate curve of the fuel output).

The basic idea of the present invention is therefore to limit the dynamic movement of the tappet of the passive valve by utilizing the magnetic force that is generated when a permanent magnet is moved in an electrically conductive element. This results in a magnetic force opposing the movement of the magnet, which can be used advantageously in the injector for injecting fuel.

According to an advantageous modification of the present invention, it may be provided that in a closed state of the passive valve, the reciprocating tappet of the passive valve is in contact with a stop element in order to seal at least one passage of the stop element.

The stop element defines at least one opening which, in a lifted state of the tappet, has a fluid connection to the fuel feed line of the injector, so that the fuel flows through the passive valve. This at least one opening is closed when the tappet comes into contact with the stop element, which can be a valve plate of an injector, for example, as a result of which the flow connection is prevented. In order to determine the maximum stroke of the tappet, a counter stop can also be provided, against which the tappet strikes when it is at its maximum distance from the stop element. The stop element therefore has an opening that can be sealed by the tappet so that the valve can be brought into its closed position in cooperation with the tappet. The tappet can therefore only move back and forth in a linear movement between the stop and the counter-stop.

Advantageously, it can be provided that the stop element is a valve plate of the injector, wherein the valve plate can preferably be contacted from a first of its flat sides by an armature of the active valve and from the opposite second flat side by the tappet of the passive valve. Typically, an injector comprises an actively actuated armature that can be lifted from a closed position, for example with the aid of a coil. For example, it can be provided that the armature acts on the valve plate from one side and the tappet acts on the valve plate from the other side in the opposite direction. In this way, at least one passage extending through the valve plate can be sealed from both sides, which enables a particularly space-saving design of the injector. The use of the passive valve is advantageous because a very high pressure originating from the output opening of the injector (for example, generated by a combustion process in a combustion chamber) is not able to lift an armature from a closed position against its closing direction. A pressure oriented in this way is prevented by the passive valve, as this moves into its closed position or is forced into the closed position by such a pressure emanating from the combustion chamber.

Advantageously, according to the invention, it can be provided that the stop surface of the tappet contacting the stop element, in particular the valve plate, is configured as a flat seal, cone seal and/or ball seal. It is clear to the skilled person that a large number of possible contact pairings can lead to a desired sealing effect. However, the flat seal is particularly advantageous, as during an opening process in which the tappet is pushed away from the valve plate or the stop element from a closing position, the fuel flow from the fuel feed line impinges directly on a flat plate, resulting in a high dynamic pressure and high compressive forces which open the tappet quickly and reliably.

According to an optional embodiment of the present invention, it may be provided that the tappet is a permanent magnet or comprises a permanent magnet whose magnetic poles are arranged offset in the longitudinal direction of the injector.

The arrangement of the different poles of the permanent magnet offset to the direction of movement of the tappet creates magnetic field lines that extend parallel to the direction of movement of the tappet (and therefore also to the longitudinal direction of the injector) to a large extent. This is necessary in order to generate corresponding eddy currents in the tappet guide, which-due to the resulting magnetic fields-cause the desired braking effect of the tappet movement.

According to an optional modification of the present invention, it may be provided that the tappet has the shape of a circular ring in cross-section, so that in an open position of the passive valve, a flow of fuel can be passed through its central recess.

In a closed position, an end face of the tappet, for example the contour of a circular ring, seals off at least one passage of a stop element. The at least one passage is therefore covered by the end face (contour of the circular ring) and prevents fuel from flowing out in the downstream direction of the passive valve in the event of direct contact.

Furthermore, according to the present invention, it may be provided that the tappet guide surrounds the tappet on the circumferential side and preferably extends along the entire maximum possible stroke of the tappet. Preferably, the tappet guide also extends beyond the length of the maximum stroke of the tappet, for example by more than 5%, more than 10% or more than 15% of the total length of the stroke.

The arrangement of the tappet guide over the entire maximum possible stroke of the tappet ensures that the desired braking effect also occurs in the stop areas of the tappet. It is clear to the skilled person that a two-part or multi-part design of the tappet guide can also be provided, in which, for example, a central area of the tappet guide seen in the longitudinal direction has an interruption so that no braking effect acts on the tappet there.

According to the invention, it can also be provided that the tappet guide is made of a different material than the housing of the injector. For example, the housing of the injector may have a recess to accommodate the tappet guide. However, it is also possible for the entire housing of the injector to be made of an electrically conductive material that is not or only slightly magnetizable. Separate insertion of a tappet guide into the housing or the relevant housing section can then be omitted.

According to an advantageous embodiment of the present invention, it may be provided that the tappet guide has the shape of a sleeve, preferably wherein the inner diameter of the sleeve corresponds to the outer diameter of the tappet or is not more than 10%, preferably 5%, more preferably 2% larger than the outer diameter of the tappet. The coordinated dimensions of the inner diameter of the tappet guide and the outer diameter of the tappet (which has or consists of the permanent magnet) ensure that the magnetic field lines emanating from the permanent magnet have to overcome the smallest possible air gap when passing into the tappet guide, which opposes the magnetic force induced in the tappet guide.

According to a further advantageous modification of the present invention, it may be provided that the tappet is arranged slidingly in the tappet guide and/or the different poles of the tappet provided with the permanent magnet or of the tappet configured as a permanent magnet are arranged offset relative to one another in the sliding direction.

Furthermore, according to the invention, it may be provided that the stop element with which the tappet is in contact in a closed position of the passive valve is made of a non-magnetizable or only weakly magnetizable material.

The stop element, which may in particular be the valve plate of the injector, can then not be magnetized by the tappet, regardless of the strength of the magnetization of the tappet. This is particularly advantageous if the tappet has direct contact with the stop element (the valve plate) in the closed position, so that “sticking” due to magnetic attraction between the valve tappet and valve plate cannot occur.

According to a further, optional embodiment of the present invention, it may be provided that a spacer element is provided between a stop element for the closed position, in particular a valve plate, and the tappet in order to set a maximum magnetic force between the stop element and the tappet, the spacer element preferably being a disk, a foil or a coating attached to the stop element and/or the tappet. The spacer element is made of a non-magnetic or only weakly magnetic material, in particular a plastic, e.g. polymide.

This is particularly advantageous if the stop element, for example the valve plate, is a ferromagnetic material that itself becomes magnetic when exposed to a high magnetic field. In order to avoid a very high magnetic force, which typically occurs when there is direct contact between the permanent magnet and the stop element, a spacer element is provided which maintains a minimum distance from the permanent magnet to the stop element. The material for implementing the spacer element can typically be a plastic, in particular a polymide. The tappet and/or the valve plate can also be provided with a corresponding coating. This prevents undesirably high magnetic forces from occurring, which could lead to a magnet being imprinted in the ferromagnetic material of the stop element. The spacer element can therefore regulate the maximum permissible magnetic force that may act on the stop element, in particular the valve plate, by ensuring that the distance between the permanent magnet and the stop element does not fall below a minimum value.

According to a further advantageous embodiment of the present invention, it may be provided that the tappet guide and the tappet are arranged coaxially to one another, preferably with the tappet guide surrounding the tappet on the circumferential side.

Furthermore, according to the invention, it may be provided that the tappet guide and the tappet are each configured to be rotationally symmetrical and have a common axis of rotation or axis of rotation. The common axis of rotation or axis of rotation can extend parallel to the longitudinal direction of the injector or be identical to it. Rotationally symmetrical or rotationally symmetrical components are easier to install and simpler to manufacture.

The invention also relates to an internal combustion engine with a fuel injection system, in particular with a direct gas injection system, in particular with a direct hydrogen injection system, comprising an injector according to any one of the variants discussed above.

Further features, details and advantages of the invention will become apparent from the following description of the figures. The Figures show in:

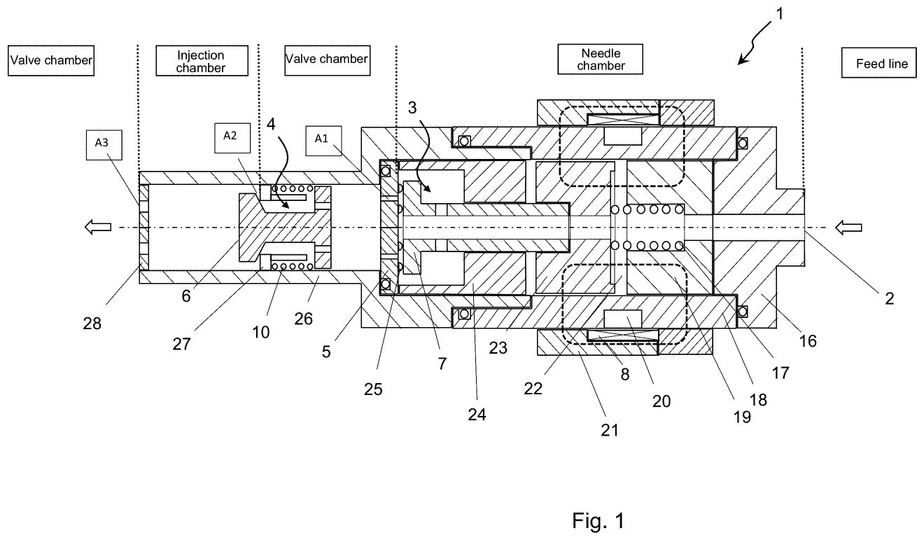

FIG. 1: a schematic sectional view of an injector according to the prior art,

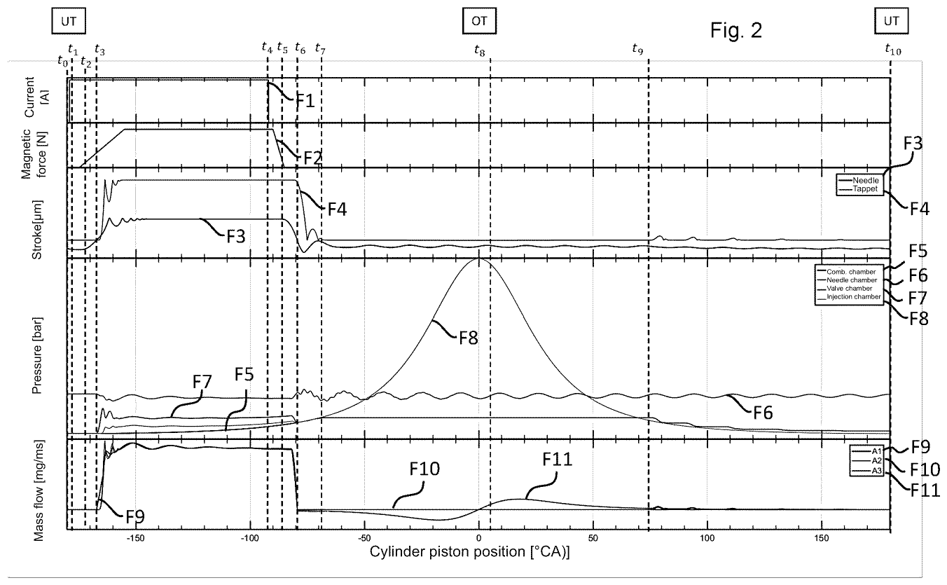

FIG. 2: a representation of different states of components and pressures in an injector,

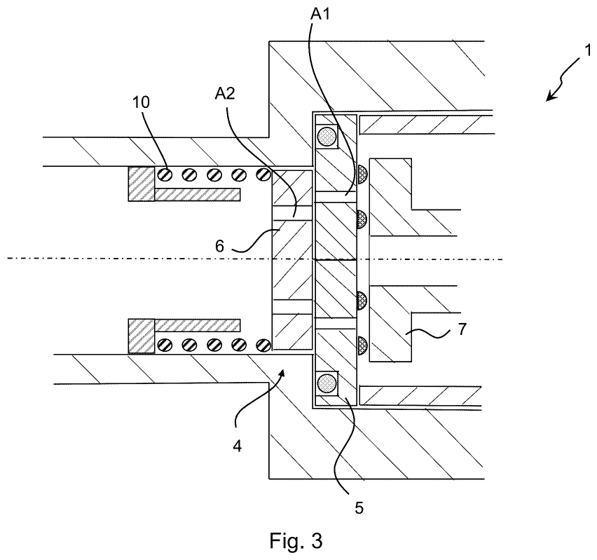

FIG. 3: a schematic partial sectional view of an injector in the area of the passive valve,

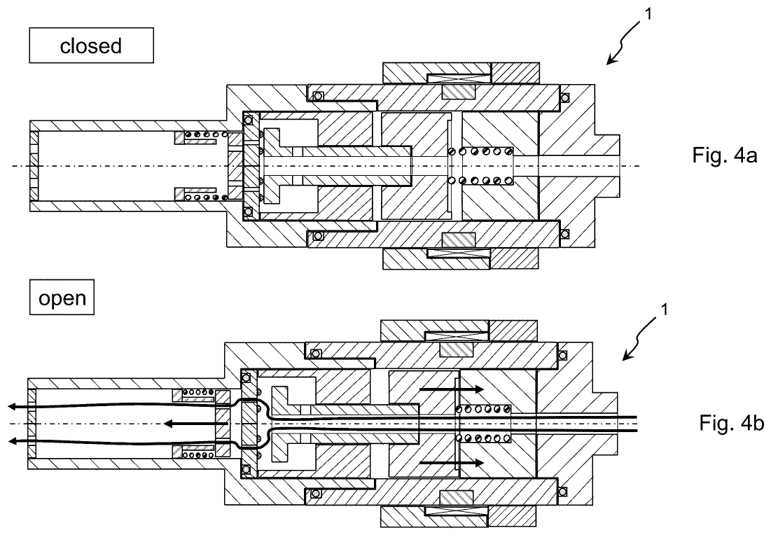

FIG. 4a-b: a schematic sectional view of the injector in a closed and an open state,

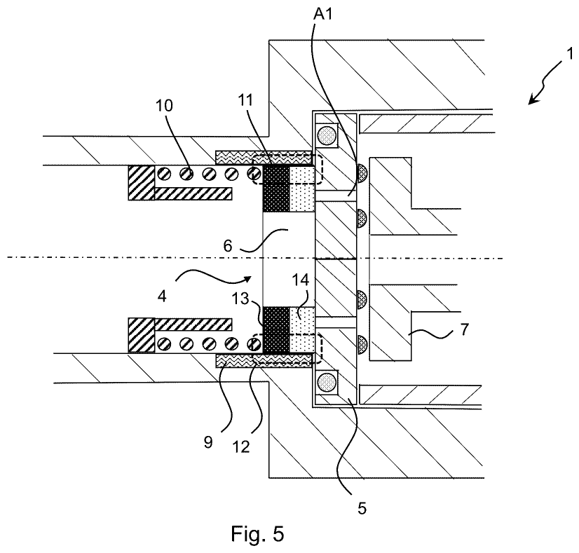

FIG. 5: a schematic partial sectional view of an injector according to the invention in a closed state,

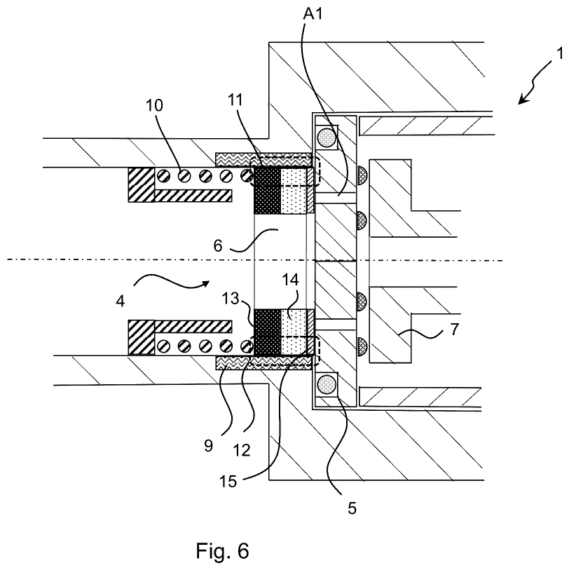

FIG. 6: a schematic partial sectional view of the injector according to the invention according to a second embodiment in a closed state, and

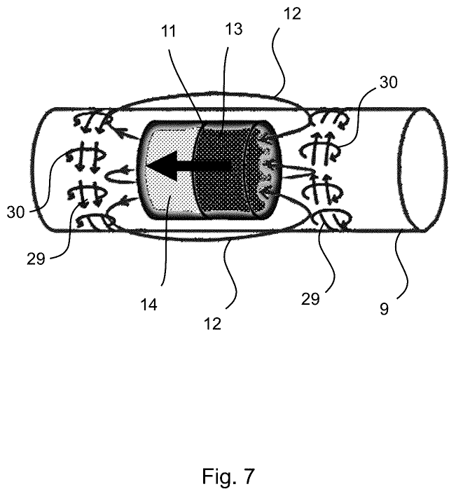

FIG. 7: a sketchy illustration to explain the underlying operating principle of the present invention.

The following detailed description of the figures in FIG. 1 is explained with reference to an injector for injecting a gaseous fuel, although it is clear to the skilled person that the invention also includes an injector for injecting a different fuel.

FIG. 1 shows a longitudinal section of an injector 1 for injecting a gaseous fuel, for example hydrogen, into a combustion chamber. The injector 1 comprises an injector housing in which various components of the injector 1 are located. A fuel feed line 2 is provided on the connection side for introducing a fuel into the injector 1. First, the fuel or another combustible fluid (e.g. hydrogen) is fed through a hole in a cover 16 extending approximately centrally in the injector housing and then through a fluid channel of an armature counterpart 19, a through hole in the armature base 23 and the hollow interior of the armature 7, which is sometimes also called a hollow needle or simply a needle, to the end of the armature 7 remote from the connection side.

Depending on the position of the armature 7 relative to the valve plate 5, the openings A1 that penetrate the valve plate 5 are closed or open. In the state shown in FIG. 1, the openings A1 are closed by pressing the armature 7 against the valve plate 5, as the end face of the armature 7 covers the opening contours of the openings A1. To improve the tightness, scaling elements 25 can be provided that extend around the opening contours of the passages A1 and contact the end face of the armature 7 in a sealing state. If the passages A1 are closed by the end face of the armature 7, the fluid flow of the fuel is stopped at this point of the injector 1 and there is no downstream flow of fuel beyond the valve plate 5.

If, on the other hand, the passages A1 are released, which is realized by lifting the armature 7 away from the valve plate 5, the fuel introduced into the injector 1 at a certain pressure flows out and exits via the several passages A1 on the side of the valve plate 5 spaced from the armature 7. After flowing through a passive valve 4, which is provided in the injector 1, the pressurized fuel flows out of the injector through the injection cap 28. After flowing through the injection cap 28, the fuel delivered by the injector 1 is then typically located outside the injector 1 in a combustion chamber. In addition, compression of the fuel typically takes place in the combustion chamber 16, where the fuel then ignites or is ignited.

The passive valve 4, which is located on the side of the valve plate 5 facing away from the armature 7, serves to keep a very high pressure prevailing in the combustion chamber away from the armature 7. Otherwise, the very high pressure prevailing in the combustion chamber could act on the armature 7 and move it away from its position closing at least one passage A1. In a subsequent working step of the injector 1, the fuel required for combustion would then no longer be introduced into the combustion chamber, but an already at least partially burnt mixture, which could lead to an interruption of the combustion process or at best to a lower output of the combustion process.

The passive valve 4 comprises a valve tappet 6, a valve guide 27 and a valve spring 10, which urges the valve tappet 6 in a closing direction, so that fuel only flows out via the opening contour A2 of the passive valve 4 when there is a pressure on the side of the passive valve 4 facing the valve plate 9 that is greater by at least the restoring force of the valve tappet 6 exerted by the valve spring 10, when a pressure prevails on the side of the passive valve 4 facing the valve plate 9 that is greater than the pressure prevailing on the side facing away from the passive valve 4 towards the valve plate 5 by at least the restoring force of the valve tappet 6 exerted by the valve spring 10. This prevents a fluid from flowing in from the side of the passive valve 4 facing the combustion chamber.

The armature 7 can be moved back and forth in the longitudinal direction of the injector 1. The movement of the armature 7, which can be in one piece or consist of an armature base 23 and an armature tip (also known as a needle or hollow needle), is controlled via an active valve 3, which is a solenoid valve in the present illustration of FIG. 1. The armature 7 is configured in such a way that it reacts to the magnetic force generated by a coil 8. The coil 8 can optionally have current flowing through it in such a way that the resulting magnetic force moves the armature 7 in the direction of the fuel connection 2. This movement causes the armature 7 to be lifted relative to the valve plate 5, which opens up the passages A1 in the valve plate 5 so that fuel can flow through the valve plate 5.

For precise guidance of the armature 7 along the longitudinal axis of the injector, an armature guide 24 can be provided, which surrounds an outer side of the armature 7 on the circumferential side.

An air gap 22 is provided between the armature 7 and the armature counterpart 19, which is closed or reduced when the coil 8 is energized.

In order to improve the magnetic flux when implementing the active valve 3 as a solenoid valve, the coil 8 can be surrounded on its circumferential outside by an back iron 21, in which the magnetic field can propagate particularly well. The housing component directly surrounding the armature element 5 and the armature counterpart 27, which is also preferably made of a magnetizable material, behaves in a similar way. It can therefore be advantageous if the pole tube 18, which is a component of the injector housing 2, is also made of iron or another ferromagnetic material. The same also applies to the armature counterpart 19, which advantageously also consists of a magnetizable material.

A visualized representation of the magnetic field lines is illustrated in each case by the dotted, closed line that extends in a circle around the coil. The magnetic force pulls the armature element 7 (together with the armature base 23) towards the armature counterpart 19 and thus lifts it away from the valve plate 5 or from the passages A1 that break through the valve plate 5, so that fuel can flow in towards the passive valve, from where fuel is ultimately introduced into the combustion chamber via the injection cap 28.

FIG. 2 shows the basic behavior of the injector 1 during an injection. In the initial position at the time to at bottom dead center (BDC) of the cylinder piston, armature 7 and valve tappet 6 are pressed into their respective stops by the pretensioned armature spring 17 and passive valve spring 10 and close the throttle points A1 and A2, which connect the needle chamber to the valve chamber and the valve chamber to the injection chamber when armature 7 and valve tappet 6 are open. The pressure in the injector 1 corresponds to the pressure in the feed line, the pressure in the combustion chamber and in the injection chamber corresponds to the boost pressure during the intake phase of the cylinder piston, in which fresh air is drawn into the combustion chamber via the intake valves. The pressure in the valve chamber corresponds approximately to the combustion chamber pressure and depends, among other things, on the armature spring 17, the pressure in the combustion chamber during the phase in which the hot combustion gases are expelled via the exhaust valves of the combustion chamber and any preceding injection. The functional diagram below is simplified and does not take into account the change in charge due to the opening and closing of the inlet and outlet valves of the combustion chamber.

At the time t₁ a voltage signal is applied to the coil 8 of the actuator via the electrical contacts so that the current F1 in the electrical circuit increases to a defined end level. The current-carrying coil 8 induces a magnetic field in the actuator, the magnetic field lines of which spread out in a torus shape around the coil (see FIG. 1). The magnetic field builds up a magnetic force F2 in the air gap between armature 7 and armature counterpart 19, wherein at the point in time t₂ the armature 7 is attracted to the armature counterpart 19 as soon as the magnetic force F2 exceeds the closing force (sum of the pre-tensioning force of the armature spring 17 and the compressive forces on the armature 7). The build-up of the magnetic field and thus the magnetic force F2 is delayed by eddy currents in the iron parts of the magnetic circuit. The armature 7 is integrally or firmly connected to the armature base 23, so that the armature 7 moves uniformly with the armature stroke (or also: needle stroke) F3. As soon as the sealing element 25 on the valve plate 5 t₃ is no longer in contact with the end face of the armature 7, the connection between the needle chamber and the valve chamber is released so that the fuel flows from the needle chamber into the valve chamber. This increases the pressure in the valve chamber. As soon as the pressure difference from the valve chamber to the injection chamber corresponds to a force difference on the valve tappet 6 equal to the preload force of the valve spring 10, the passive valve 4 opens, i.e. the valve tappet 6 moves away from the seat along a valve tappet stroke F4 and releases the connection between the valve chamber and the injection chamber so that fuel flows from the valve chamber into the injection chamber. This results in an increase in pressure in the injection chamber (see F8: Pressure in the injection chamber). The fuel continues to flow downstream through the opening(s) A3 in the injection cap 28 into the combustion chamber. The injection cap 28 is configured in such a way that the flow can be introduced into the combustion chamber in a defined state (jet orientation, inlet impulse, jet pattern, etc.). The open state of armature 7 and valve tappet 6 is maintained during the entire remaining flow phase. The current level can be reduced (e.g. by a PWM voltage signal) as soon as the armature 7 is fully open and a possible bounce does not lead to the armature 7 closing. During injection, the engine cylinder is in the compression phase, so that the combustion chamber pressure F5 rises steadily.

To end the blow-in process, the power supply is terminated by the control unit so that the current F1 through coil 8 is reduced to zero (point in time t₄). Due to the eddy currents, the magnetic force F2 is also reduced with a time delay. As soon as the magnetic force F2 is less than the sum of the closing force of the armature spring 17 and the hydraulic forces on the armature 7, the armature 7 begins to close uniformly (point in time t₅); see also F3, F4. If the end face of the armature 7 hits the sealing element 25 of the valve plate 5, the connection between the needle chamber and the valve chamber is separated and the fuel flow from the needle chamber into the valve chamber is interrupted (point in time t₆). This causes the pressure in the valve chamber F7 to drop. If the pressure difference from the valve chamber F7 to the injection chamber F8 corresponds to a force difference on the valve tappet 6 equal to the valve spring force, the valve tappet 6 moves back into its closed position on the valve seat 27 and is pressed against the seat 27 by the increasing pressure F5 in the combustion chamber and thus in the injection chamber, so that the fuel connection between the valve chamber and the injection chamber is interrupted (possibly after a phase of bouncing of the tappet on the valve seat 27) (points in time t₆-t₇). The injection process is now complete. During the further compression phase of the combustion chamber up to top dead center (TDC) in the period t₇-t₈ the air-fuel mixture in the injection chamber is compressed, while it expands in the subsequent expansion phase (period t₈-t₉), wherein the further interim increase in combustion chamber pressure F5 due to combustion is not shown here for the sake of simplicity. If the pressure in the combustion chamber drops to such an extent that the difference in pressure forces on the valve tappet 6 corresponds to the preload force of the armature spring 17 (point in time t₉), the valve tappet 6 opens again briefly so that some of the fuel in the valve chamber escapes into the combustion chamber. This process depends on the spring force and can occur repeatedly (time period t₉-t₁₀).

The respective mass flow rate of the fuel via the passages A1 of the valve plate 5, the passages A2 of the tappet 6 and the passages A3 of the injection cap 28 is indicated by F9, F10 and F11.

FIG. 3 shows a partial sectional view of an injector 1 with focus on the passive valve 4. It can be seen that the tappet 6 of the passive valve 4 is provided on an underside of the valve plate 5 and seals the passages A1 provided in the valve plate 5 by direct contact.

The tappet 6 is pushed into its closed position by a spring element 10, wherein the spring element 10 is supported on a counter stop arranged downstream. It can also be seen that the seal created by the tappet 6 on the underside of the valve plate 5 is a flat seal or a flat seat. The configuration shown with a direct seal on the underside of the valve plate 5 is very space-saving and enables very short injectors 1 in the longitudinal direction.

FIG. 4a and FIG. 4b show a closed state (FIG. 4a) and an open state (FIG. 4b) of the injector. In FIG. 4b, the flow of fuel from the fuel feed line to the injection cap is shown with arrows. The movement of the components required from their respective closed position to create the fluid connection between the fuel feed line and the injection cap is also highlighted by arrows. It can be seen that the armature is lifted out of its closed position due to the coil being energized, which causes the highly pressurized fuel to force the tappet of the passive valve out of its closed position. Once the components have moved accordingly, the highly pressurized fuel can flow out of the injector 1 from the fuel feed line to the injection cap.

FIG. 5 shows a first embodiment of the present invention, wherein the movable tappet 6 is also urged into its closed position with the aid of a spring element 10. It should be noted that other implementations of the urging element, which is configured in the present case with the aid of a spring element, are also possible. As can be seen, the tappet 6 is implemented by a permanent magnet 11 whose magnetic poles 13, 14 are offset along the direction of movement. The south pole 13 is therefore arranged, for example, on the side at a distance from the stop element 5, whereas the north pole 14 is provided on the side of the tappet 6 facing the stop element 5. The magnetic field lines 12 formed by the permanent magnet 11 are shown in FIG. 5 by a dotted, closed circle. If the tappet 6 is moved along its direction of movement, i.e. lifted off the valve plate 5 or moved towards it, the magnetic field emanating from the tappet 6 generates eddy currents in the tappet guide 9. These eddy currents in turn generate a magnetic force that opposes the direction of movement of the tappet 6, causing the tappet to slow down. In particular, this reduces the bouncing of the tappet 6 when contacting the valve plate 5 or the counter-stop, which leads to better predictability and a more even output of the fuel rate dispensed by the injector. The ripple in the fuel rate caused by the bouncing, as can be seen in FIG. 2 for example (see F9 and F10), therefore no longer occurs.

The tappet 6, which is configured as a permanent magnet, is surrounded on the circumference by the tappet guide 9, wherein the tappet guide 9 has the shape of a sleeve. The sleeve 9 can be configured in such a way that it completely surrounds the tappet 6 on the circumference. Furthermore, the tappet guide 9 is arranged continuously over the entire length of the two stop points of the tappet 6, which are spaced apart from one another in the longitudinal direction, and preferably also extends beyond this. Thus, the tappet guide 9 is also provided on the counter stop at a region further away in the longitudinal direction, which can never come into direct contact with the tappet 6, although this is intentional, since the magnetic field emanating from the tappet 6 can also extend into sections further away. According to the invention, it can therefore be provided that the tappet guide not only extends in the stroke range of the tappet 6, but also extends beyond it.

FIG. 6 shows a schematic partial sectional view of the injector according to the invention according to a second embodiment in a closed state. The illustration is similar to that in FIG. 5, but now a spacer element 15 is provided in the intermediate region between the tappet 6 and the valve plate 5 (stop element), which regulates the magnetic force of the tappet 6 acting on the valve plate 5. If the valve plate 5 is made of a ferromagnetic material, a magnetic field can be impressed into the ferromagnetic material during continuous and repetitive physical contact with a permanent magnet, so that an increased magnetic force is generated which prevents the tappet 6 from opening from its closed position. In the worst case, the magnetic field impressed in this way can then cause the tappet 6 to stick to the valve plate 5 during an actual opening process, so that the desired opening of the valve can no longer be achieved. In order to prevent such sticking, a spacer element 15 can be arranged between the tappet 6 and the valve plate 5, which consists of a non-magnetizable or only weakly magnetizable material. The spacer element can take the form of a disk or be implemented via a coating or a foil on one end face of the valve plate 5 or the tappet 6. Plastic, for example polymide, is a particularly suitable material for the spacer element.

FIG. 7 is a sketchy illustration to explain the underlying operating principle of the eddy current brake that is used for the present invention. The tappet guide 9 and the permanent magnet 11 arranged therein, which represents the tappet 6, can be seen. If the permanent magnet 11 is now moved, the magnetic field 12 of the permanent magnet 11 causes eddy currents 29 to be induced in the valve guide 9. These eddy currents 29 in turn cause-like any movement of a charged particle—a corresponding magnetic field 30, which opposes the magnetic field of the moving permanent magnet 11, so that the movement of the permanent magnet 11 (shown by the thick black arrow) is slowed down. This effect is used during the movement of the tappet 6 in the passive valve to prevent a high speed of the tappet 6 when it strikes a stop or a counter-stop, thereby reducing bouncing. This also prevents unduly high mechanical stress on the tappet 6 caused by the unbraked impact. Reducing the high impact speed results in the tappet having a longer service life and improved fatigue strength, making the overall system more robust.

### LIST OF REFERENCE SYMBOLS

1 Injector
2 Fuel feed line
3 Active valve
4 Passive valve
5 Valve plate
6 Tappet/valve inset
7 Armature
8 Coil
9 Tappet guide/valve insert guide
10 Spring element
11 Permanent magnet
12 Magnetic field lines
13 Magnetic south pole
14 Magnetic North Pole
15 Distance element
16 Housing cover
17 Armature spring
18 Pole tube
19 Armature counterpart
20 Bypass
21 Back iron
22 Air gap
23 Armature base
24 Armature guide/needle guide
25 Sealing element
26 Injection pipe
27 Valve guide
28 Injection cap
A1 Passage of the valve plate
A2 Passage of the tappet
A3 Passage of the blow-in cap

1. Injector for injecting fuel, comprising:
a fuel feed line for introducing a fuel under high pressure,
an active valve which can be actively switched and is configured to close or open at least one passage in order to selectively open or interrupt a flow connection from the fuel feed line to an area downstream of the active valve, and
a passive valve which is arranged downstream of the active valve and can be passively switched into a closing state or releasing state by different pressure ratios applied upstream and downstream of the passive valve in order to release or interrupt a flow connection from upstream of the passive valve to an area downstream of the passive valve,
wherein
a reciprocating tappet of the passive valve comprises a permanent magnet or is a permanent magnet, and
a tappet guide is provided for guiding the reciprocating movement of the tappet, which is electrically conductive and non-magnetizable or only weakly magnetizable, or
a reciprocating tappet of the passive valve is electrically conductive and non-magnetizable or only weakly magnetizable, and
a tappet guide is provided for guiding the reciprocating movement of the tappet, which comprises a permanent magnet or is a permanent magnet.

2. Injector according to claim 1, wherein in a closed state of the passive valve the reciprocating tappet of the passive valve is in contact with a stop element in order to seal off at least one passage of the stop element.

3. Injector according to claim 2, wherein the stop element is a valve plate, wherein the valve plate can be contacted from one of its flat sides by an armature of the active valve and from the opposite flat side by the tappet of the passive valve.

4. Injector according to claim 2, wherein the stop surface of the tappet contacting the stop element is configured as a flat seal, cone seal and/or ball seal.

5. Injector according to claim 1, wherein the tappet is a permanent magnet or comprises a permanent magnet whose magnetic poles are arranged offset in the longitudinal direction of the injector.

6. Injector according to claim 1, wherein the tappet has the shape of a circular ring in cross-section, so that in an open position of the passive valve a flow of fuel can be passed through in its central recess.

7. Injector according to claim 1, wherein the tappet guide surrounds the tappet on the circumferential side and extends along the entire maximum possible stroke of the tappet.

8. Injector according to claim 1, wherein the tappet guide is made of a different material than the housing of the injector.

9. Injector according to claim 1, wherein the tappet guide has the shape of a sleeve.

10. Injector according to claim 1, wherein the tappet is arranged slidingly in the tappet device and/or the different poles of the tappet provided with the permanent magnet or of the tappet configured as a permanent magnet are arranged offset with respect to one another in the sliding direction.

11. Injector according to claim 2, wherein the stop element, with which the tappet is in contact in a closed position of the passive valve, is made of a non-magnetizable or only weakly magnetizable material.

12. Injector according to claim 1, wherein a spacer element is provided between a stop element for the closed position, and the tappet, in order to set a maximum magnetic force between the stop element and the tappet.

13. Injector according to claim 1, wherein the tappet guide and the tappet are arranged coaxially to each other.

14. Injector according to claim 1, wherein the tappet guide and the tappet are each configured to be rotationally symmetrical and have a common axis of rotation.

15. Internal combustion engine with a fuel injection system, comprising an injector according to claim 1.

16. Injector according to claim 1, wherein the injector is for injecting gaseous hydrogen.

17. Injector according to claim 9, wherein an inner diameter of the sleeve corresponds to an outer diameter of the tappet or is not more than 10% larger than the outer diameter of the tappet.

18. Injector according to claim 12, wherein the spacer element is a disk, a foil or a coating attached to the stop element and/or the tappet, which is made of a non-magnetic or only weakly magnetic material.
